(19) United States
(12) Patent Application Publication
(10) Pub. No.: US 2025/0142298 A1
(43) Pub. Date: May 1, 2025

(54) Method for Geocoding Data for an Agricultural Operation

(71) Applicant: CamoAg, Inc., Palatine, IL (US)

(72) Inventors: Chris Sprehe, Crystal Lake, IL (US); Mike Parent, Deerfield, IL (US)

(73) Assignee: CamoAg, Inc., Palatine, IL (US)

(21) Appl. No.: 18/926,237

(22) Filed: Oct. 24, 2024

Related U.S. Application Data
(60) Provisional application No. 63/593,637, filed on Oct. 27, 2023.

(51) Int. Cl. H04W 4/18; G06Q 40/10; G06Q 50/02

(52) U.S. Cl. CPC H04W 4/185; G06Q 40/10; G06Q 50/02

(57) ABSTRACT

A method for geocoding data about an agricultural operation. A producer name and source address are received as input at a geocoded warehouse component. The producer name and source address are to a geocoding component and address variants for the source address are retrieved. The source address and address variants are transmitting to a normalizing component that corrects the address and converts them to a standard format. The normalized address data is sent to one or more geocoding services that retrieve geospatial data for the normalized address data. The retrieved geospatial data is scored, assigned a unique location ID, and displayed to a user.

### CROSS REFERENCE TO RELATED APPLICATIONS

This application claims priority to U.S. Provisional Patent Application No. 63/593,637, filed on Oct. 27, 2023, the entirety of which is hereby incorporated herein by reference.

### FIELD OF THE INVENTION

The disclosure relates generally to a method for aggregating data for an agricultural operation, producer, or non-operating landowner. In particular, the disclosure relates to a computer implemented method for geocoding data about an agricultural operation, producer, or non-operating landowner using data from multiple sources.

### BACKGROUND OF THE INVENTION

Agricultural contributes $1.3 trillion to the United States GDP, yet it is one of the most difficult markets to sell into given the highly fragmented nature of the market. Producers (aka farmers) and other landowners frequently operate under multiple business entities. For example, producers commonly own equipment as one entity, farm as another entity, own livestock as another entity, and partner with family members to farm as another entity. It can be very difficult for an outsider to match up the various entities with the producer behind them. Third parties who wish to work with a producer currently have a difficult time determining the true scope of the producer's operation, and determining the value of the producer's agricultural operation often relies on hearsay and “tribal” knowledge that the third party can obtain about how the producer is doing business. Others have attempted to aggregate data in a way that provides a complete picture of a producer's operation, but to date none have been able to thoroughly match various farming entities to the producers behind them. Therefore, an improved method for geocoding data for an agricultural operation, producer, or non-operating landowner is desired.

### SUMMARY OF THE INVENTION

In accordance with various embodiments of the invention, a computer implemented method for geocoding data about an agricultural operation, producer, or non-operating landowner is provided. In one embodiment, a producer name and a producer source address are received at a geocoded warehouse component. The producer source address may be transmitted or otherwise communicated to a geocoding component which retrieves address variants associated with the producer source address at the geocoding component. The address variants may be retrieved from one or more publicly available geocoding services. The producer source address and the address variants are transmitted to a normalizing component which normalizes the producer source address and the address variants to obtain a normalized source address and normalized address variants, and the normalized source address and normalized address variants are transmitted back to the geocoding component. The geocoding component retrieves geospatial data for the normalized source address and the normalized address variants and transmits the retrieved geospatial data back to the geocoded warehouse component. The geospatial data for the normalized producer source address and the normalized address variants are scored at the geocoded warehouse component, and the assigned score represents a level of confidence in the accuracy of the geospatial data that was retrieved. The geocoded warehouse component assigns a unique location ID to the producer source location and stores the geospatial data for the normalized source address and the normalized address variants with the unique location ID. Information related to the unique location ID may be displayed to a user one or more parcels of land associated with the unique location ID on a map or another graphical representation of the data. The method may further comprise retrieving UCC filing data from publicly available sources and displaying the UCC filing data to a user. The method may further comprise retrieving tax parcel data from publicly available sources and displaying the tax parcel data to a user. The method may further comprise retrieving operator data from publicly available sources and displaying the operator data to a user. While the term “producer” is used throughout the specification, the disclosed method may also be used to retrieve information for a producer, agricultural operation, or non-operating landowner without departing from the scope of the disclosure. Similarly, references to the term “agricultural operation” could also be applied to a producer or non-operating landowner without departing from the scope of the disclosure.

### BRIEF DESCRIPTION OF DRAWINGS

FIG. 1 illustrates a system for geocoding data about an agricultural operation in accordance with one embodiment of the invention.

FIG. 2 illustrates a method for geocoding data about an agricultural operation in accordance with one embodiment of the invention.

### DETAILED DESCRIPTION OF THE INVENTION

Some embodiments of the present invention will now be described more fully hereinafter with reference to the accompanying drawings, in which some, but not all, embodiments of the invention are shown. Various embodiments of the invention may be embodied in many different forms and should not be construed as limited to the embodiments set forth herein; rather, these embodiments are provided so that this disclosure will satisfy applicable legal requirements. Like reference numerals refer to like elements throughout. Some components of the apparatus or method steps are not shown in one or more of the figures for clarity and to facilitate explanation of embodiments of the present invention.

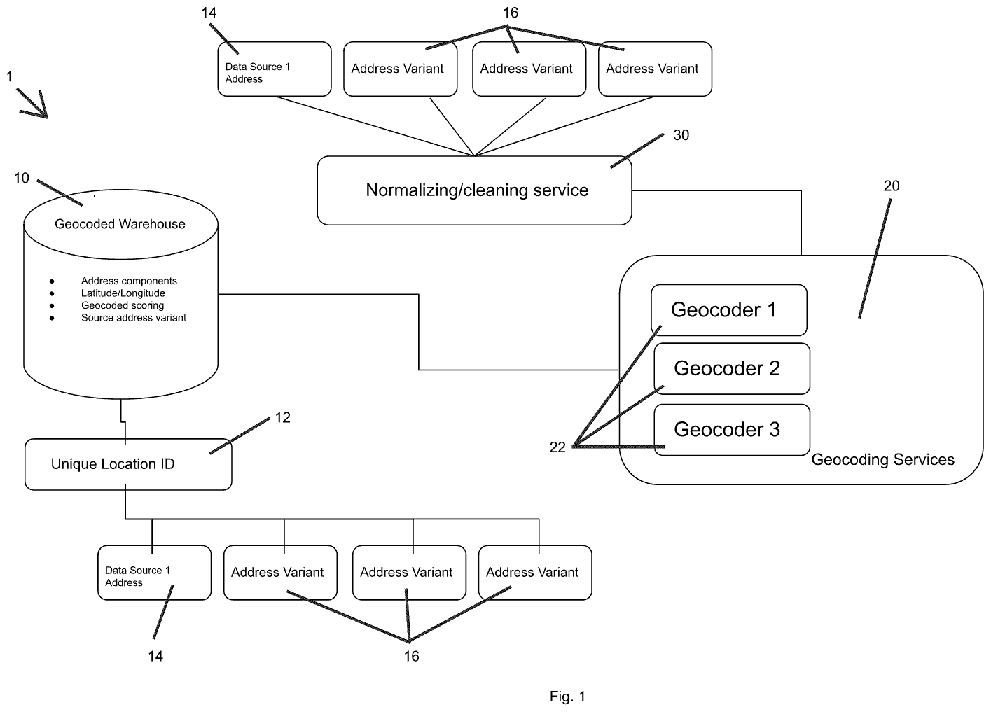

In accordance with one embodiment, FIG. 1 illustrates a system 1 for geocoding data for an agricultural operation. As shown in FIG. 1, the system 1 comprises a geocoded warehouse component 10, a geocoding component 20, and a normalizing component 30.

### Geocoded Warehouse Component 10

The geocoded warehouse component 10 comprises a computing device and software running on the computing device configured to support a method for geocoding data for an agricultural operation. The geocoded warehouse component 10 is configured to perform tasks associated with storing and scoring address data.

Each unique location is assigned a unique location ID 12 by the geocoded warehouse component 10. Information for each unique location ID 12 is also stored on the geocoded warehouse component 10. In one embodiment, the information stored for each unique location ID 12 includes the source address 14, address variants 16 associated with the source address 14, the latitude and longitude of the source address 14 and each address variant 16, and a score associated with the latitude and longitude of the source address 14 and each address variant 16. The source address 14 is the address of the location that was input by a user of the system 1. Address variants 16 include alternate versions of the location's address, which may include alternative spellings of the source address 14 or incorrect address information that corresponds to the location. The source address 14 and each address variant 16 are each assigned a score by the geocoded warehouse component 10. The score indicates the accuracy or level of confidence that the latitude and longitude provided by the geocoding component 20 of the source address 14 or address variant 16 is correct.

The geocoded warehouse component 10 communicates via a network with the geocoding component 20, passing address information to the geocoding component 20, and receiving latitude and longitude data from the geocoding component 20. The geocoded warehouse component 10 also communicates with user computing devices, receiving queries in the form of a producer name and source address 14 input by a user using a software interface on the user's own computing device, and transmitting information associated with the producer back to the user using the software interface on the user's computing device.

The geocoded warehouse component 10 may alternatively be referred to as the geocoded warehouse 10 without departing from the scope of the disclosure.

### Geocoding Component 20

The geocoding component 20 comprises a computing device and software running on the computing device configured to retrieve geospatial data from one or more geocoders 22 or geocoders 22. Geocoding component 20 is capable of receiving address data from the geocoded warehouse 10 as input, retrieving geospatial data for the address inputs, and passing the geospatial data back to the geocoded warehouse component 10. In one embodiment, the geospatial data retrieved by the geocoders 22 is in the form of latitude and longitude. As shown in FIG. 1, three geocoders 22 denoted Geocoder 1, Geocoder 2, and Geocoder 3 are shown; however, any number of geocoders 22 may be used without departing from the scope of the disclosure. The one or more geocoders 22 may be publicly available geocoding services or paid-for geocoding services. Addresses for rural or agricultural land can be particularly problematic for geocoders 22 to process. In many cases, the address for a single location may have several spelling variations. For example, the word “county” included in a rural address may be spelled out as “county” or abbreviated as “co” or “cty”. Misspellings and otherwise incorrect information are also especially prevalent in rural address data. Because of these issues, a particular geocoder 22 will often fail to return latitude and longitude data for a rural address. By using multiple geocoders 22, there is an increased chance that at least one of the geocoders 22 will be able to retrieve the latitude and longitude for the provided address.

The geocoding component 20 communicates via a network with the geocoded warehouse component 10, passing address information from the geocoded warehouse 10 to the geocoding component 20, and passing latitude and longitude data from the geocoding component 20 back to the geocoded warehouse component 10. The geocoding component 20 also communicates with the normalizing component 30, passing original address data from the geocoding component 20 to the normalizing component 30, and passing cleaned or normalized address information from the normalizing component 30 to the geocoding component 20.

The geocoding component 20 may alternatively be referred to as geocoding services 20 without departing from the scope of the disclosure.

### Normalizing Component 30

The normalizing component 30 comprises a computing device and software running on the computing device configured to support a method for geocoding data for an agricultural operation. The normalizing component 30 is configured to receive address information from the geocoding component 20, normalize and clean the address data, and return the normalized and cleaned address data back to the geocoding component 20.

As previously discussed with respect to the geocoding component 20, addresses for rural or agricultural land can be particularly problematic for geocoders 22 to process. In many cases, the address for a single location may have several spelling variations. For example, the word “county” included in a rural address may be spelled out as “county” or abbreviated as “co” or “cty”. Misspellings and otherwise incorrect information are also especially prevalent in rural address data. Because of these issues, a particular geocoder 22 will often fail to return latitude and longitude data for a rural address. Using multiple geocoders 22 is one way the disclosed methods improve the geocoding results returned by the system 1. Normalizing and cleaning the address data using normalizing component 30 is another way that the system 1 provides improved geocoding results.

To normalize and clean the address data, the geocoding component 20 communicates the original or raw address data, which may be the source address 14 and one or more address variants 16, to the normalizing component 30. Each raw address is corrected to have standardized formatting and spelling. The normalized source address 14 and normalized address variants 16 are passed back to the geocoding component 20, which can then retrieve geospatial data for the normalized addresses.

The normalizing component 30 may alternatively be referred to as the normalizing/cleaning component 30 or the normalizing/cleaning service 30 without departing from the scope of the disclosure.

### Method 100

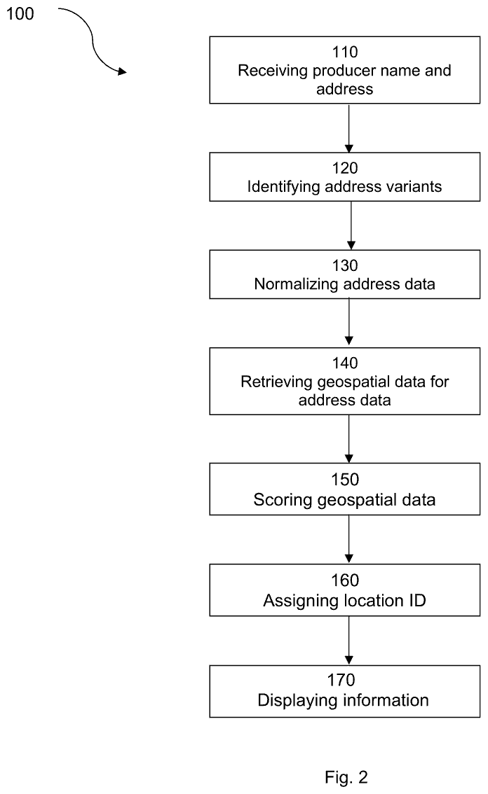

As shown in FIG. 2, a method 100 for geocoding data for an agricultural operation is shown. While the term “producer” is used throughout the specification, the disclosed method may also be used to retrieve information for a producer, agricultural operation, or non-operating landowner without departing from the scope of the disclosure. Similarly, references to the term “agricultural operation” could also be applied to a producer or non-operating landowner without departing from the scope of the disclosure. The method 100 begins at step 110 with receiving a producer or non-operating landowner name and source address 14 at the geocoded warehouse component 10. The producer name and source address 14 are input by a user when the user enters the name and source address 14 into a software interface on the user's own computing device. The producer name and source address 14 are communicated to the geocoded warehouse component 10 over a data network. If the producer name and or source address are already stored in the geocoded warehouse component 10, then the unique location ID 12 and data associated with that unique location ID 12 are communicated back to the user's computing device and displayed on the software interface with which the user is interacting with the system 1. The data associated with the unique location ID 12 may include a link to the producer's platform in the interface that initially shows a map with the producer's home base of operation or principal place of business. Any UCC filings, agricultural liens, or other liens associated with the producer's name may be displayed, indicating if the producer has any loans for agricultural equipment or mortgages for land. In the case of land matched to the producer's name, the other parcels of land that the producer owns may be graphically displayed on a map. Land owned outright by the producer may be shown in a different format that land that is covered by a mortgage; for example, parcels of land owned outright may be outlined in green on the map and parcels of land where there are mortgages may be outlined in white. Clicking on a particular parcel of land on the map causes the interface to display specifics regarding the loan or mortgage. UCC filing or mortgage data may also be displayed, indicating equipment loans, land ownership, and recent purchases. Tax parcel data may also be displayed, indicating ownership of parcels of land associated with the producer. Operator data may also be displayed, indicating who is actually working on the land as this may differ from the producer who owns the land. Any other geospatial data could be included, including weather events, transmission lines, mineral rights, purchases on the part of the producer, grain storage data, etc. If no data associated with the producer name or source address 14 is found in the geocoded warehouse component 10, then the method proceeds to step 120.

At step 120, the source address 14 is transmitted to the geocoding component 20 for identification of address variants 16. Addresses for rural or agricultural land can be particularly problematic for geocoders 22 to process due to various spellings and formats used in rural addresses as well as incompleteness of or errors in publicly available location data. Addresses variants 16 include addresses with different spellings, formats, or errors that are likely to refer to the same parcel of land as the source address 14.

At step 130, the source address 14 and any address variants 16 identified at step 120 are transmitted to the normalizing component 30 and the data is normalized or cleaned. As part of the normalizing or cleaning step, the source address 14 and address variants 16 are converted to a standardized address format using standard spellings. Problematic patterns in the address formatting are recognized and fixed. Errors or incompleteness detected in the source address 14 or address variants 16 are also corrected. Thus, a normalized source address 14 and normalized address variants 16 are created at step 130, and the normalized address data is communicated back to the geocoding component 20.

At step 140, the normalized source address 14 and any normalized address variants 16 are communicated to one or more geocoders 22 for retrieval of geospatial data for each of the normalized source address 14 and normalized address variants 16. The geocoders 22 or geocoders 22 are publicly available platforms that take an address as input and return geospatial data, typically in the form of latitude and longitude. As shown in FIG. 1, three geocoders 22 denoted Geocoder 1, Geocoder 2, and Geocoder 3 are shown; however, any number of geocoders 22 may be used without departing from the scope of the disclosure. Because inconsistencies, incompleteness, and errors are particularly prevalent in rural address data, there is a high chance that a particular geocoder 22 will fail to return geospatial data for a particular address. By using multiple geocoders 22 at step 140 in combination with normalized address data from step 130, the method 100 has the advantage of increased chances of retrieving accurate geospatial data for the source address 14.

At step 150, the geospatial data retrieved at step 140 by the geocoding component 20 is returned to the geocoding warehouse component 10 where a score is assigned to the geospatial data retrieved for each of the source address 14 and address variants 16. The score assigned at step 150 reflects a degree of confidence that the geospatial data retrieved for each address is accurate.

At step 160, a unique location ID 12 is assigned to the location associated with the name and source address 14 originally provided at step 110, and data associated with the unique location ID 12 is stored by the geocoding warehouse component 10. The stored data associated with the unique location ID 12 may include address components, latitude and longitude, and confidence score for the source address 14 and each address variant 16.

At step 170, data associated with the unique location ID may be transmitted back to the user and displayed in a graphical format within the interface with which the user interacts with the system 1. In addition to the location data, other information associated with the producer name or any of the source address 14 or address variants 16 may be aggregated and stored by the geocoded warehouse component 10 and displayed to the user in a graphical or other format. For example, the total amount of land, the amount of land on which the producer operates, any loans or mortgages associated with the producer's operation, third parties that the producer partners with in operating the producer's farm, companies the producer does business with, equipment the producer owns, and recent borrowing may be aggregated and displayed to the user. Each piece of information tied to the producer is stored with the unique location ID 12 at the geocoded warehouse component 10, and the process of geocoding and creating the relationships between the data has proven to be unique and valuable for people seeking to gain a complete understanding of a producer's operation.

Many modifications and other embodiments of the invention will come to mind to one skilled in the art to which this invention pertains having the benefit of the teachings presented in the foregoing descriptions and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

1. A computer implemented method for geocoding data about an agricultural operation comprising:
receiving a producer name and a producer source address at a geocoded warehouse component;
transmitting the producer source address to a geocoding component and retrieving address variants associated with the producer source address at the geocoding component;
transmitting the producer source address and the address variants to a normalizing component, normalizing the producer source address and the address variants at the normalizing component to obtain a normalized source address and normalized address variants, and transmitting the normalized source address and normalized address variants back to the geocoding component;
retrieving geospatial data for the normalized source address and the normalized address variants at the geocoding component and transmitting the retrieved geospatial data back to the geocoded warehouse component;
scoring the geospatial data for the normalized producer source address and the normalized address variants at the geocoded warehouse component;
assigning a unique location ID to the producer source location and storing the geospatial data for the normalized source address and the normalized address variants with the unique location ID; and
displaying to a user one or more parcels of land associated with the unique location ID on a map.

2. The method of claim 1 wherein the address variants are retrieved from a geocoding service.

3. The method of claim 1 wherein the geospatial data for the producer source address and address variants is retrieved from a plurality of geocoding services.

4. The method of claim 1 further comprising retrieving UCC filing data and displaying the UCC filing data to the user.

5. The method of claim 1 further comprising retrieving tax parcel data and displaying the tax parcel data to the user.

6. The method of claim 1 further comprising retrieving operator data and displaying the operator data to the user.
